(19) United States
(12) Patent Application Publication
(10) Pub. No.: US 2022/0016718 A1
(43) Pub. Date: Jan. 20, 2022

(54) DRIVING ADAPTER

(71) Applicant: FINE FORGE INDUSTRY CORPORATION, Nantou County (TW)

(72) Inventor: Kuo-Lung CHEN, Nantou County (TW)

(21) Appl. No.: 17/225,718

(22) Filed: Apr. 8, 2021

(30) Foreign Application Priority Data
Jul. 14, 2020 (TW) 109208953

(51) Int. Cl. B23B 31/36; B25B 23/00

(52) U.S. Cl. CPC B23B 31/36; B25B 21/00; B25B 23/0035

(57) ABSTRACT

A driving adapter which is configured to be applied to a driving head of a rotary tool is provided. The driving adapter includes: a main body, including a socket portion, an insertion portion connected with the socket portion and a projection connected with the insertion portion in an axial direction, the socket portion including a connection hole which is quadrangular and extends along the axial direction, the insertion portion being a quadrangular post and extending along the axial direction, a diametric dimension of the insertion portion being different from a diametric dimension of the connection hole, the projection including an annular groove around the axial direction; an elastic retainer, being non-closed, disposed within and around the annular groove; and a cushion, disposed within the annular groove, being radially abuttable against and between the projection and the elastic retainer.

### BACKGROUND OF THE INVENTION

### Field of the Invention

The present invention relates to a driving adapter.

### Description of the Prior Art

Generally, in fastening operations, in order to save manpower, pneumatic or electric rotary tools are usually used. The conventional rotary tool generally has a driving head for adaption of one of various socket tools. However, the driving head of the conventional rotary tool has a fixed size, while the socket tools have respective connection holes of various sizes which do match with a diametric dimension of the driving head of a rotary tool, and thus it is necessary to prepare many rotary tools having respective driving heads of various diametric dimensions. As a result, is takes a lot of money to purchase many rotary tools, and there is a big problem of storing the rotary tools.

The present invention is, therefore, arisen to obviate or at least mitigate the above-mentioned disadvantages.

### SUMMARY OF THE INVENTION

The main object of the present invention is to provide a driving adapter, which can provide adaption of a driving tool which has a connection hole having a diametric dimension that does match with a diametric dimension of a driving head of a rotary tool.

To achieve the above and other objects, a driving adapter is provided, the driving adapter is configured to be applied to a driving head of a rotary tool, the driving adapter including: a main body, including a socket portion, an insertion portion connected with the socket portion and a projection connected with the insertion portion in an axial direction, the socket portion including a connection hole which is quadrangular and extends along the axial direction, the connection hole being configured to be sleeved around the driving head of the rotary tool, the insertion portion being a quadrangular post and extending along the axial direction, a diametric dimension of the insertion portion being different from a diametric dimension of the connection hole, the insertion portion being configured to be assembled with a driving tool, the projection including an annular groove around the axial direction; an elastic retainer, being non-closed, disposed within and around the annular groove; and a cushion, disposed within the annular groove, being radially abuttable against and between the projection and the elastic retainer.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are stereograms of a preferred embodiment of the present invention;

FIG. 3 is a breakdown drawing of a preferred embodiment of the present invention;

FIG. 4 is a cross-sectional view of a preferred embodiment of the present invention;

FIG. 5 is a partial enlargement of FIG. 4;

FIGS. 6 to 8 are drawings showing assembling to a rotary tool according to a preferred embodiment of the present invention; and

FIG. 9 is a stereogram of another preferred embodiment of the present invention.

### DETAILED DESCRIPTION OF THE PREFERRED EMBODIMENTS

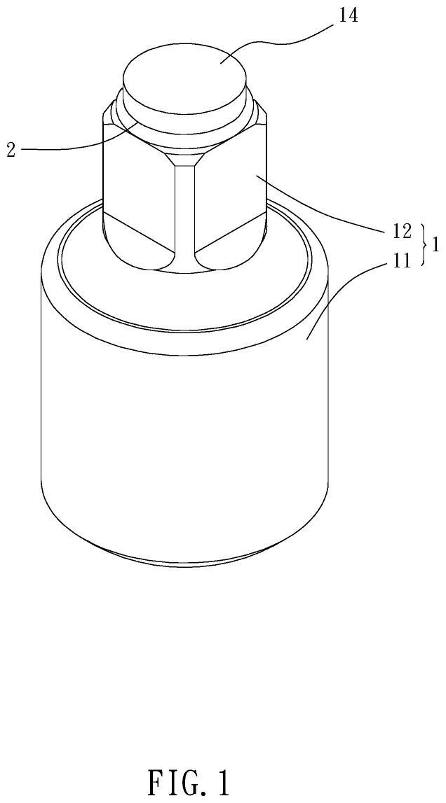

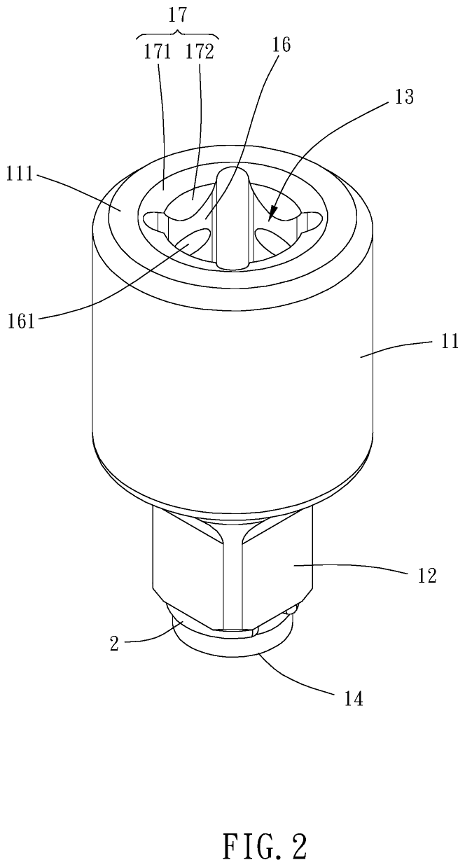

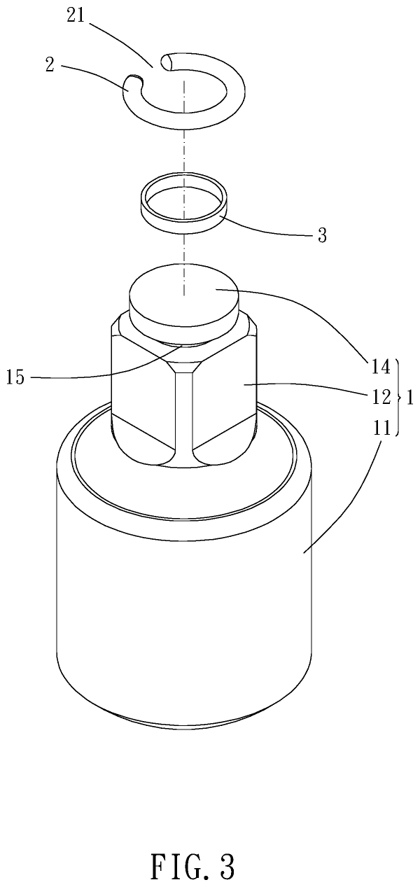

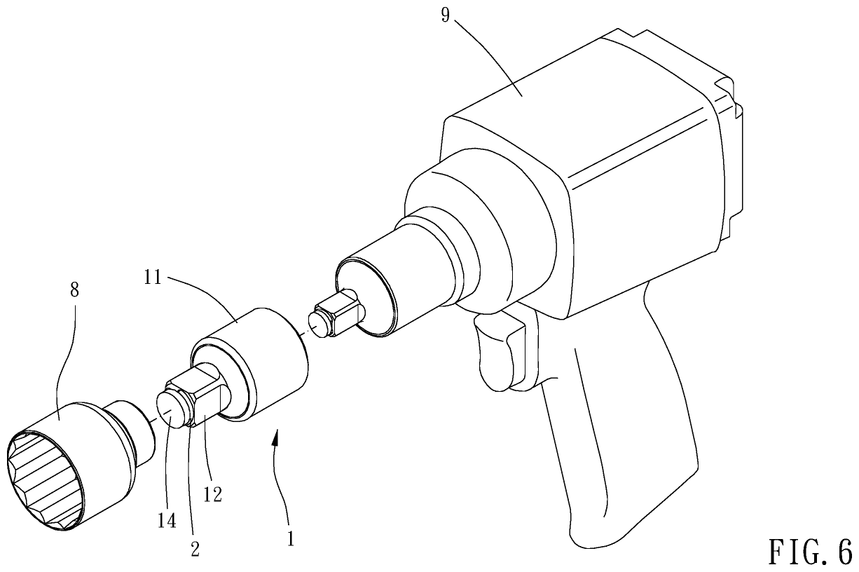

Please refer to FIGS. 1 to 8 for a preferred embodiment of the present invention. A driving adapter of the present invention is configured to be applied to a driving head of a rotary tool 9. The driving adapter includes a main body 1, an elastic retainer 2 and a cushion 3.

The main body 1 includes a socket portion 11, an insertion portion 12 connected with the socket portion 11 and a projection 14 connected with the insertion portion in an axial direction, the socket portion 11 includes a connection hole 13 which is quadrangular and extends along the axial direction, the connection hole 13 is configured to be sleeved around the driving head of the rotary tool 9, the insertion portion 12 is a quadrangular post and extending along the axial direction, a diametric dimension of the insertion portion 12 is different from a diametric dimension of the connection hole 13, the insertion portion 12 is configured to be assembled with a driving tool 8, an end of the insertion portion 12 away from the socket portion 11 includes a projection 14 extending along the axial direction, and the projection 14 includes an annular groove 15 around the axial direction.

The elastic retainer 2 is non-closed, is disposed within and around the annular groove 15, and has a gap 21 between two ends of the elastic retainer 2, wherein the elastic retainer 2 is elastically deformable to elastically abut against the driving tool 8 so that the driving tool 8 and the driving adapter can be stably assembled. Moreover, the cushion 3 is disposed within the annular groove 15 and is radially abuttable against and between the projection 14 and the elastic retainer 2, which reduces abrasion of the projection 14 and the elastic retainer 2 and allows the driving adapter to be stably assembled with the driving tool 8.

In this embodiment, the driving tool 8 is a socket tool. In assembling, the connection hole 13 of the socket portion 11 is sleeved around the driving head of the rotary tool 9 and the insertion portion 12 is inserted to the driving tool 8, thus providing adaption of a driving tool which has a connection hole having a diametric dimension that does match with a diametric dimension of the driving head of the rotary tool 9.

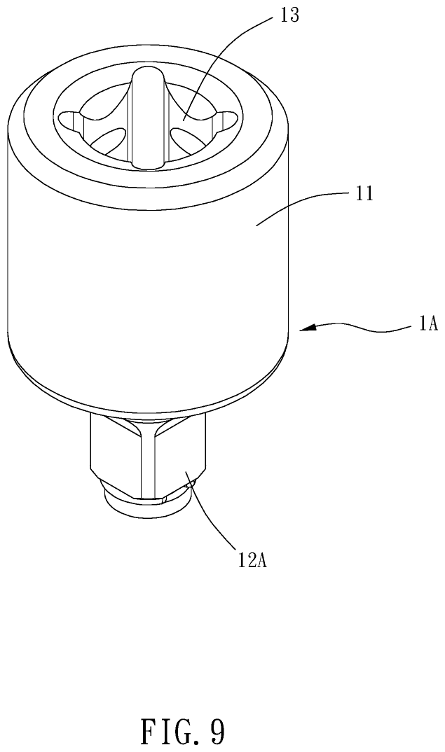

In this embodiment, the diametric dimension of the insertion portion 12 is larger than the diametric dimension of the connection hole 13, for application of a driving tool having a connection hole with a diametric dimension larger than the diametric dimension of the driving head of the rotary tool 9. In an alternative embodiment, the diametric dimension of the insertion portion 12A of the main body 1A may be smaller than the diametric dimension of the connection hole 13 (as shown in FIG. 9).

Preferably, the socket portion 11 further includes four inner sidewalls 16 defining the connection hole 13 and a guiding portion 17 located at a side of the connection hole 13 adjacent to an end surface 111 of the socket portion 11, and at least two of the four inner sidewalls 16 opposite to each other respectively have a restricting groove 161 spaced apart from the guiding portion 17 and radially disposed thereon. The guiding portion 17 is configured to guide insertion of the driving head of the rotary tool 9, and the restricting groove 161 is configured to axially restrict a retainer 91 disposed on the driving head of the rotary tool 9. Specifically, the guiding portion 17 includes at least one first inclined surface 171 extending inwardly from the end surface 111 and at least one second inclined surface 172 adjacently connected with the at least one first inclined surface 171, and the at least one first inclined surface 171 and the at least one second inclined surface 172 are oblique relative to the axial direction so that the driving head of the rotary tool 9 can easily correspond to the connection hole 13 and be smoothly inserted into the connection hole 13. In this embodiment, the guiding portion 17 includes one said first inclined surface 171 extending around the connection hole 13 and four said second inclined surfaces 172 respectively disposed on one of the four inner sidewalls 16, which is convenient to be processed and provides good guiding effect.

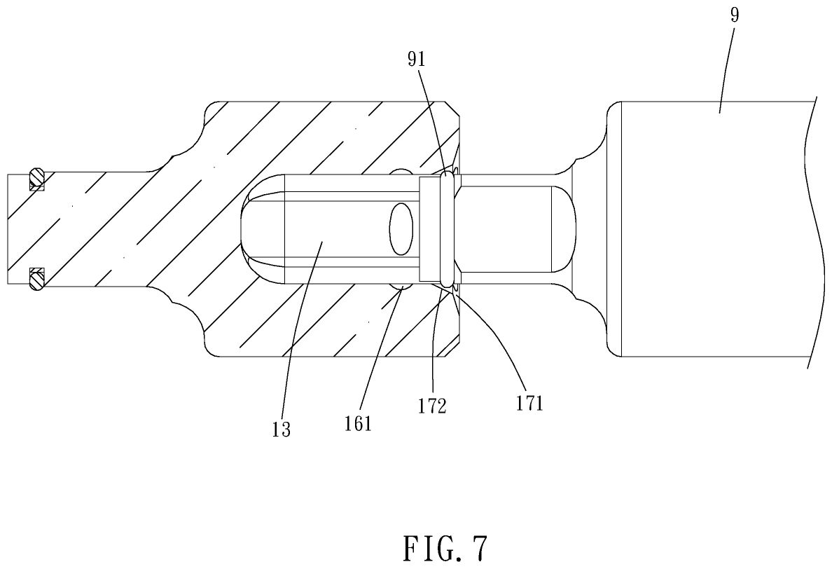

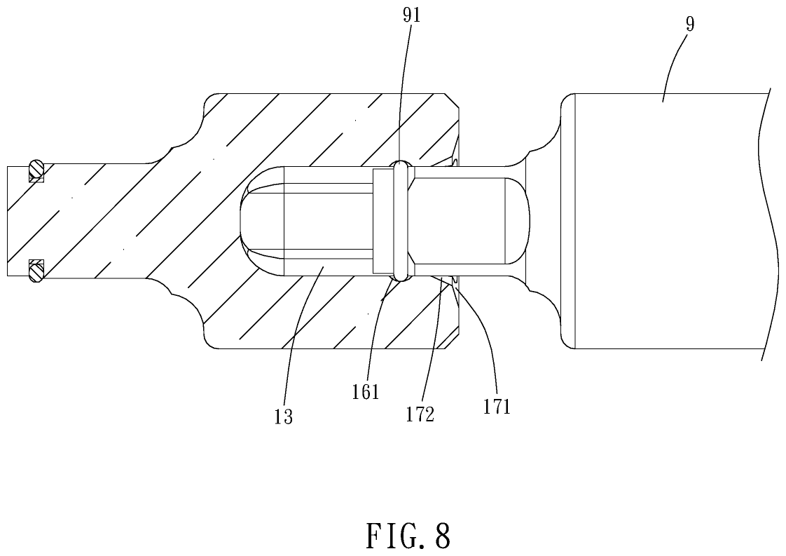

In assembling, the retainer 91 of the rotary tool 9 is moved along the said first inclined surface 171 to the four said second inclined surfaces 172, and the driving adapter is rotated to let the driving head of the rotary tool 9 correspond to the connection hole 13, as shown in FIG. 7; after that, the driving head of the rotary tool 9 is pushed into the connection hole 13 and the retainer 91 is restricted within each said restricting groove 161, as shown in FIG. 8.

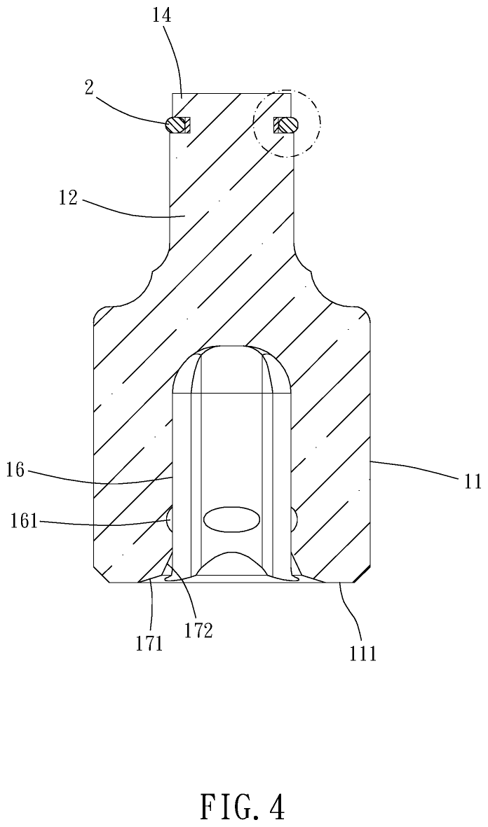

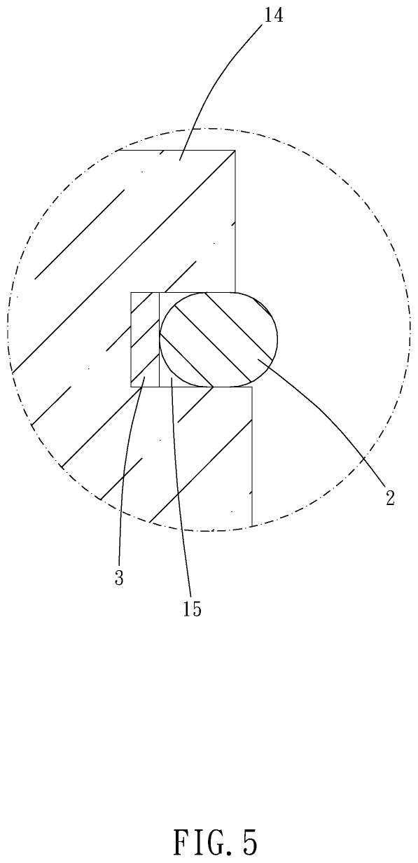

Specifically, the elastic retainer 2 is a C-shaped retainer and the cushion 3 is an O-ring made of elastomer, thus making the installation of the elastic retainer 2 and the cushion 3 within the annular groove 15 easier. A cross section of the cushion 3 is rectangular so that the elastic retainer 2 can be stably abutted against the cushion 3 (as shown in FIGS. 4 and 5). In this embodiment, an internal diameter of the elastic retainer 2 is larger than a diametric dimension of an annular bottom face of the annular groove 15, an external diameter of the elastic retainer 2 is larger than the diametric dimension of the projection 14, so that the elastic retainer 2 is not fittingly abutted against the cushion 3 without being pressed. When the insertion portion 12 is inserted into the driving tool 8, the elastic retainer 2 is urged by the inner surface of the driving tool 8 and the cushion 3 is deformed so that the elastic retainer 2 is elastically abutted against the inner surface of the driving tool 8. In this embodiment, the elastic retainer 2 has a circular cross-section, and thus it is easy to manufacture the elastic retainer 2. In other embodiment, the cushion may be C-shape; the cushion may be made of other materials such as plastic, rubber, etc.; the cross section of the cushion may be circular.

In this embodiment, the annular groove 15 is disposed at an end of the projection 14 toward the socket portion 11, and the external diameter of the elastic retainer 2 is smaller than the diametric dimension of the insertion portion 12.

Specifically, the projection 14 is cylindrical, and the diametric dimension of the projection 14 is smaller than the diametric dimension of the insertion portion 12, which can avoid relative rotation of the driving tool 8 and the insertion portion 12.

In this embodiment, the socket portion 11 is cylindrical, and the diametric dimension of the insertion portion 12 is smaller than the diametric dimension of the socket portion 11.

Given the above, by assembling of the connection hole of the socket portion and the driving head of the rotary tool and assembling of the insertion portion and the driving tool, it can provide adaption of a driving tool which has a connection hole having a diametric dimension that does match with a diametric dimension of the driving head of the rotary tool.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A driving adapter, configured to be applied to a driving head of a rotary tool, the driving adapter including:
a main body, including a socket portion, an insertion portion connected with the socket portion and a projection connected with the insertion portion in an axial direction, the socket portion including a connection hole which is quadrangular and extends along the axial direction, the connection hole being configured to be sleeved around the driving head of the rotary tool, the insertion portion being a quadrangular post and extending along the axial direction, a diametric dimension of the insertion portion being different from a diametric dimension of the connection hole, the insertion portion being configured to be assembled with a driving tool, the projection including an annular groove around the axial direction;
an elastic retainer, being non-closed, disposed within and around the annular groove; and
a cushion, disposed within the annular groove, being radially abuttable against and between the projection and the elastic retainer.

2. The driving adapter of claim 1, wherein the diametric dimension of the insertion portion is smaller than the diametric dimension of the connection hole.

3. The driving adapter of claim 1, wherein the diametric dimension of the insertion portion is larger than the diametric dimension of the connection hole.

4. The driving adapter of claim 1, wherein the elastic retainer is a C-shaped retainer.

5. The driving adapter of claim 1, wherein an internal diameter of the elastic retainer is larger than a diametric dimension of an annular bottom face of the annular groove.

6. The driving adapter of claim 1, wherein the annular groove is disposed at an end of the projection toward the socket portion.

7. The driving adapter of claim 6, wherein an external diameter of the elastic retainer is larger than a diametric dimension of the projection.

8. The driving adapter of claim 6, wherein an external diameter of the elastic retainer is smaller than the diametric dimension of the insertion portion.

9. The driving adapter of claim 6, wherein the projection is cylindrical.

10. The driving adapter of claim 9, wherein a diametric dimension of the projection is smaller than the diametric dimension of the insertion portion.

11. The driving adapter of claim 1, wherein the socket portion is cylindrical.

12. The driving adapter of claim 1, wherein the socket portion further includes four inner sidewalls defining the connection hole and a guiding portion located at a side of the connection hole adjacent to an end surface of the socket portion, and at least two of the four inner sidewalls opposite to each other respectively have a restricting groove spaced apart from the guiding portion and radially disposed thereon.

13. The driving adapter of claim 12, wherein the guiding portion includes at least one first inclined surface extending inwardly from the end surface and at least one second inclined surface adjacently connected with the at least one first inclined surface, and the at least one first inclined surface and the at least one second inclined surface are oblique relative to the axial direction.

14. The driving adapter of claim 2, wherein the elastic retainer is a C-shaped retainer; an internal diameter the elastic retainer is larger than a diametric dimension of an annular bottom face of the annular groove; the annular groove is disposed at an end of the projection toward the socket portion; an external diameter of the elastic retainer is larger than a diametric dimension of the projection; the external diameter of the elastic retainer is smaller than the diametric dimension of the insertion portion; the projection is cylindrical; the diametric dimension of the projection is smaller than the diametric dimension of the insertion portion; the socket portion is cylindrical; the elastic retainer has a circular cross-section; and the diametric dimension of the insertion portion is smaller than a diametric dimension of the socket portion.

15. The driving adapter of claim 3, wherein the socket portion is cylindrical.

16. The driving adapter of claim 3, wherein the elastic retainer is a C-shaped retainer; an internal diameter the elastic retainer is larger than a diametric dimension of an annular bottom face of the annular groove; the annular groove is disposed at an end of the projection toward the socket portion; an external diameter of the elastic retainer is larger than a diametric dimension of the projection; the external diameter of the elastic retainer is smaller than the diametric dimension of the insertion portion; the projection is cylindrical; the diametric dimension of the projection is smaller than the diametric dimension of the insertion portion; the socket portion is cylindrical; the elastic retainer has a circular cross-section; and the diametric dimension of the insertion portion is smaller than a diametric dimension of the socket portion.
